(19) United States
(12) Patent Application Publication
(10) Pub. No.: US 2025/0196675 A1
(43) Pub. Date: Jun. 19, 2025

(54) HIGH VOLTAGE / LOW VOLTAGE CHARGING ARCHITECTURE SUPPORTING UNINTERRUPTED LOW VOLTAGE SOURCE SUPPLY UNDER TRACTION BATTERY SINGLE POINT FAULT

(71) Applicant: Ford Global Technologies, LLC, Dearborn, MI (US)

(72) Inventor: Mohamed Elshaer, Canton, MI (US)

(21) Appl. No.: 18/541,622

(22) Filed: Dec. 15, 2023

(51) Int. Cl. B60L 53/22; B60L 58/20; H01M 10/42; H01M 10/44; H02J 7/02

(52) U.S. Cl. CPC B60L 53/22; B60L 58/20; H01M 10/425; H01M 10/44; H02J 7/02; B60L 2210/10; B60L 2210/30; H01M 2220/20; H02J 2207/20

(57) ABSTRACT

An automotive power system includes bidirectional power factor correction circuitry having line and neutral terminals that can be connected with an AC source, a traction battery having positive and negative terminals and a midpoint, and an isolated DC/DC converter connected between the bidirectional power factor correction circuitry and traction battery.

### TECHNICAL FIELD

This disclosure relates to automotive power systems.

### BACKGROUND

An automotive vehicle may use electrical energy to power an electric machine. The electric machine may convert this electrical energy to mechanical energy to propel the vehicle. The automotive vehicle may include various power electronics equipment to condition and store the electrical energy.

### SUMMARY

A vehicle includes bidirectional power factor correction circuitry having line and neutral terminals that can be connected with an AC source, a traction battery having positive and negative terminals and a midpoint, an isolated DC/DC converter connected between the bidirectional power factor correction circuitry and traction battery, and a plurality of switches that selectively connect the positive and negative terminals directly to the line terminals and the midpoint directly to the neutral terminal.

A method includes, after disconnecting line and neutral terminals associated with bidirectional power factor correction circuitry of a vehicle from an AC source, directly connecting the line terminals to positive and negative terminals of a traction battery of the vehicle and the neutral terminal to a midpoint of the traction battery such that power flows from the traction battery through the bidirectional power factor correction circuitry to an isolated DC/DC converter connected between the bidirectional power factor correction circuitry and traction battery.

An automotive power system includes bidirectional power factor correction circuitry having line and neutral terminals that can be connected with an AC source, a traction battery having positive and negative terminals and a midpoint, an isolated DC/DC converter connected between the bidirectional power factor correction circuitry and traction battery, and a controller. The controller, during a drive mode, connects the positive and negative terminals directly to the line terminals and the midpoint directly to the neutral terminal such that power from the traction battery flows through the bidirectional power factor correction circuitry and to the isolated DC/DC converter.

### BRIEF DESCRIPTION OF THE DRAWINGS

FIG. 1 is a schematic diagram of a system including a battery current control module.

FIG. 2 is a schematic diagram of a system including an inverter system controller.

FIG. 3 is a schematic diagram of a vehicle including an integrated battery current control module and inverter system controller.

FIG. 4 is a schematic diagram of a vehicle including an onboard charger and magnetically integrated high voltage/low voltage DC/DC converter.

FIG. 5 is a schematic diagram of a vehicle including a proposed high voltage/low voltage battery charging architecture.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Battery current control modules (BCCMs) are components in automotive vehicles, particularly those with electric or hybrid powertrains. These modules play a role in managing the flow of electric current to and from the battery. BCCMs function as control units that interface between the battery, the charging system, and the electrical loads. They monitor and control various parameters such as battery state of charge, voltage, and temperature, and based on this information, they manage the flow of current to the battery. BCCMs may facilitate charging control by overseeing the charging process of the battery, and managing the voltage and current supplied by the charging system. By monitoring the battery's state of charge and adjusting the charging parameters accordingly, BCCMs attempt to ensure the battery receives the appropriate level of charge to maintain performance. Similarly, BCCMs may be responsible for discharging control. They can manage the current output from the battery to the electrical loads in the vehicle. By controlling the current flow, BCCMs may ensure a controlled supply of power to the various electrical components and systems. BCCMs may also implement various measures for the battery. For instance, they may monitor battery temperature to prevent overheating. They may also detect overvoltage or undervoltage situations and implement measures to preclude short circuits or excessive current draw. BCCMs may feature diagnostic capabilities. These modules can monitor the health and performance of the battery system. They can log codes and provide diagnostic information, facilitating maintenance.

Communication interfaces are often incorporated into BCCMs. These interfaces, such as Controller Area Network (CAN) or LIN (Local Interconnect Network), allow BCCMs to exchange information with other vehicle systems, including the engine control unit (ECU) or the body control module (BCM). This enables coordinated operation and integrated control across various vehicle functions. BCCMs can receive commands or instructions from other control units and adjust current flow accordingly.

Inverter system controllers (ISCs) are also components in automotive vehicles with electric powertrains. They play a role in managing and controlling the power flow between the battery and electric motor. A function of an inverter system controller is to convert direct current (DC) from the battery into alternating current (AC) to power the electric motor. ISCs may act as a decision maker for the power electronics system. It may monitor various parameters such as motor speed, torque, and temperature to ensure operation. A task of ISCs is to convert DC power from the battery into three-phase AC power suitable for the electric motor. It may utilize high-power semiconductor devices, for example insulated-gate bipolar transistors (IGBTs), to control the switching of current and voltage. By modulating the pulse width and frequency of the AC waveform, the inverter system controller manages the speed and torque output of the electric motor. ISCs may provide control over the electric motor. They may use algorithms and control strategies to manage motor speed, torque, and direction of rotation. By adjusting the switching patterns of the IGBTs, the controller can vary the frequency and amplitude of the AC waveform, altering motor operation. ISCs can facilitate regenerative braking. During slowing or braking, the electric motor operates as a generator, converting the vehicle's kinetic energy into electrical energy. The inverter system controller may control the flow of energy, directing it back to the battery for storage. ISCs may be responsible for managing the thermal conditions of the power electronics system. They may monitor the temperature of the inverter and electric motor, and employ cooling systems such as fans, liquid cooling, or heat sinks to dissipate excess heat and maintain operating temperatures. ISCs may incorporate diagnostic capabilities to detect and protect against faults in the power electronics system. They may monitor various parameters such as voltage, current, and temperature values that could indicate a potential fault. If a fault is detected, the controller may take corrective actions such as shutting down the system, activating other measures, or providing fault codes for diagnostic purposes. ISCs may incorporate features such as overvoltage and undervoltage monitoring, overcurrent monitoring, and isolation monitoring.

ISCs often feature communication interfaces such as CAN or Ethernet, enabling integration with other vehicle systems. They may exchange information with the main control unit, enabling coordinated operation and facilitating diagnostics and troubleshooting. Communication interfaces also allow the controller to receive commands or instructions from the electronic control unit (ECU) and adjust the power output accordingly.

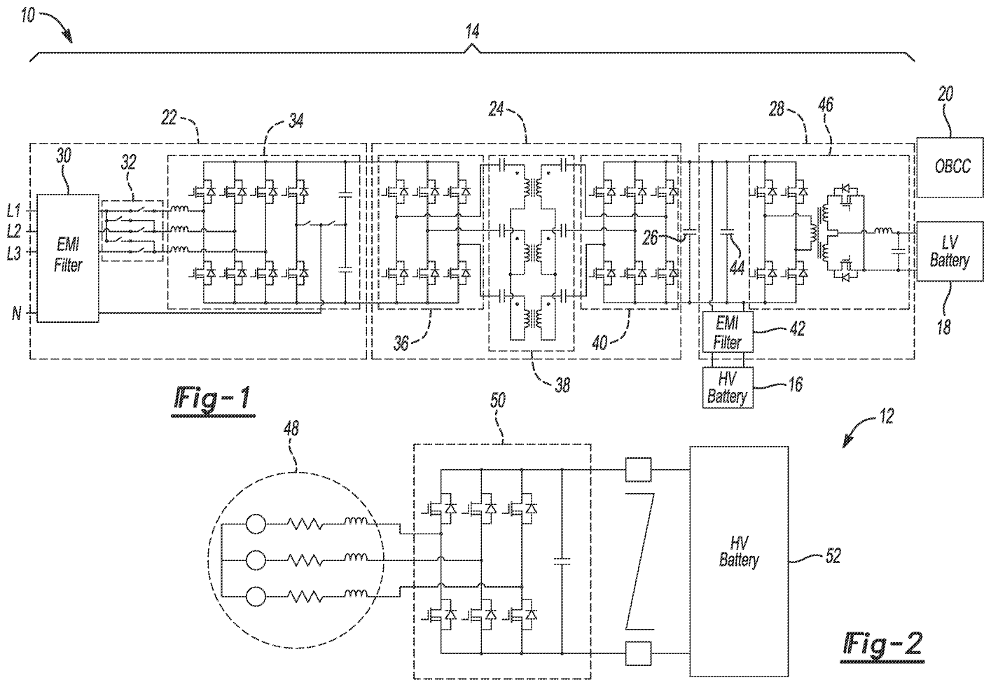

Integrating the BCCM with the ISC is conventionally considered a challenge due to the disconnecting circuitry. The schematics of typical separate systems 10, 12 are shown in FIGS. 1 and 2, respectively.

Referring to FIG. 1, the system 10 includes a BCCM 14, a traction battery 16, an auxiliary battery 18, and an onboard charge controller 20. The BCCM includes an AC/DC power factor correction circuit 22, an isolated high voltage DC/DC circuit 24, a link capacitor 26, and an isolated high voltage to low voltage DC/DC circuit 28. The isolated high voltage DC/DC circuit 24 is connected between the AC/DC power factor correction circuit 22 and link capacitor 26. The link capacitor 26 is connected between the isolated high voltage DC/DC circuit 24 and the isolated high voltage to low voltage DC/DC circuit 28. The traction battery 16 and auxiliary battery 18 are connected with the isolated high voltage to low voltage DC/DC circuit 28.

The AC/DC power factor correction circuit 22 includes an electromagnetic interference filter 30, a switch bank 32, and AC/DC power converter circuitry 34. The switch bank 32 is connected between the electromagnetic interference filter 30 and AC/DC power converter circuitry 34.

The isolated high voltage DC/DC circuit 24 includes a first switching bridge 36, a transformer 38, and a second switching bridge 40. The first switching bridge 36 is directly connected with the power converter circuitry 34. The transformer 38 is connected between the first and second switching bridges 36, 40.

The isolated high voltage to low voltage DC/DC circuit 28 includes an electromagnetic interference filter 42, a capacitor 44, and high voltage to low voltage power converter circuitry 46. The electromagnetic interference filter 42 is connected across the capacitor 44 and directly connected to the traction battery 16. The capacitor 44 is connected between the link capacitor 26 and high voltage to low voltage power converter circuitry 46. The high voltage to low voltage power converter circuitry 46 is directly connected to the auxiliary battery 18. The onboard charge controller 20 is in communication with and/or exerts control over the components of FIG. 1.

Referring to FIG. 2, the system 12 includes an electric machine 48, an ISC 50, and a traction battery 52. The ISC 50 is connected between the electric machine 48 and traction battery 52.

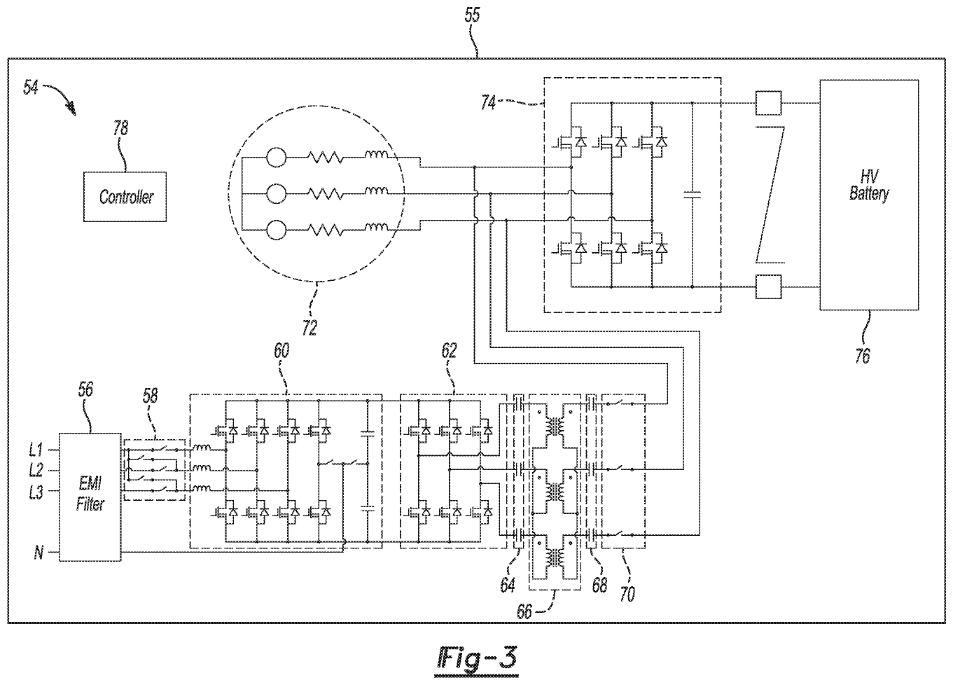

The ISC 50 has a three-phase inverter designed to drive the electric machine 48 and operates at much higher power than the BCCM 14. The BCCM 14 also has three circuits configured as a three-phase inverter/rectifier. Two disconnect circuits are required to utilize the ISC's three-phase inverter in charging/discharging the traction battery 16. The first disconnect circuit is used to disconnect the electric motor 48 from the ISC 50, and the second disconnect is used to disconnect the ISC 50 from the traction battery 52. The contactors used in these disconnect circuits must carry the ISC's full current. Adding these contactors increases bill of material counts-making electric level integration unfavorable. Package level integration, however, can provide advantages since it reduces the overall package size and/or weight, and the number of connectors and wires. The schematics of such a system 54 is shown in FIG. 3 within the context of vehicle 55.

Referring to FIG. 3, the system 54 includes an electromagnetic interference filter 56, a switch bank 58, an AC/DC power converter 60, a switching bridge 62, a capacitor bank 64, a transformer 66, a capacitor bank 68, a switch bank 70, an electric machine 72 a switching bridge 74, a traction battery 76, and a controller 78.

The switch bank 58 is connected between the electromagnetic interference filter 56 and AC/DC power converter 60. The switching bridge 62 is connected between the AC/DC power converter 60 and capacitor bank 64. The transformer 66 is connected between the capacitor banks 64, 68. The capacitor bank 68 is connected between the transformer and switch bank 70. The transformer 66 is thus also connected between the switching bridge 62 and switch bank 70. The switching bridge 74 is connected between the electric machine 72 and traction battery 76. The controller 78 is in communication with and/or exerts control over the components of FIG. 3.

The switch bank 70 is connected with a secondary side of the transformer 66: When switches of the switch bank 70 are closed, the transformer 66 is connected between the electric machine 72 and switching bridge 74 such that the switching bridge 62, transformer 66, electric machine 72, and switching bridge 74 form an isolated DC/DC power converter. The controller 78 may close the switches of the switch bank 70 responsive to a request to charge the traction battery 76. When closed energy received from, for example, a grid received at the electromagnetic interference filter 56 via L1, L2, L3, and N may be conditioned and transferred through the now formed isolated DC/DC power converter to the traction battery 76. The controller 78 may operate switches of the AC/DC power converter 60 and switching bridges 62, 64, for example, at 300 kHz when the switches of the switch bank 70 are closed (i.e., during charge mode.) When the charge is complete, the controller 78 may open the switches of the switch bank 70. The controller 78 may operate the switches of the switching bridge 64, for example, at 30 kHz (or less) when the switches of the switch bank 70 are open (e.g., during drive mode). Other switch speeds, of course, may be used.

The circuit topology presented in FIG. 3 allows for integrating a BCCM (the electromagnetic interference filter 56, switch bank 58, AC/DC power converter 60, switching bridge 62, capacitor bank 64, transformer 66, capacitor bank 68, and switch bank 70) with an ISC without using high current contractors. The add-on circuitry is interfaced directly with the ISC without disconnecting the electric machine or traction battery. The add-on circuitry includes a front-end AC/DC power factor correction circuit and portions of the isolated high voltage DC/DC circuit that is part of the BCCM. Three relays are added for disconnecting the add-on circuitry from the ISC during drive mode. The BCCM's high voltage DC/DC circuit can be designed considering the electric machine's stator winding impedance and its variations with respect to rotor position. When the vehicle is plugged into the AC grid, the add-on circuitry, ISC, and electric motor form a bidirectional AC/DC-DC/AC power converter. The BCCM's high voltage DC/DC power converter can be designed to switch at a frequency much higher than the ISC's switching frequency.

In certain circumstances, the 12V battery may act as a second power source to ensure the uninterrupted function of systems when the traction battery 76 is unavailable. Also, it may source power to key off-loads, such as the central locking system. Removing the 12V battery could be advantageous in certain circumstances. Functional requirements and normal vehicle functionality, however, should be met as if the 12V battery was present.

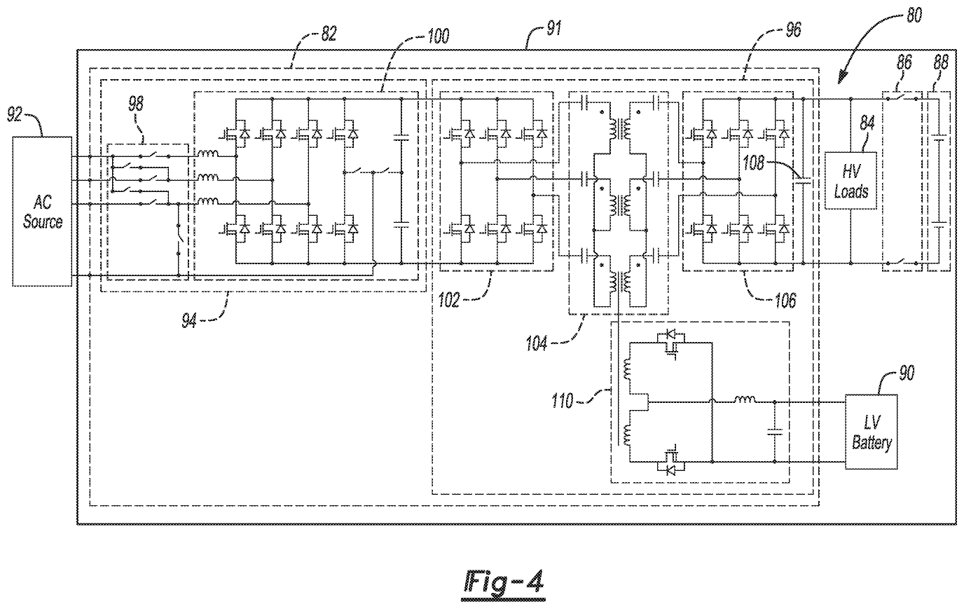

Referring to FIG. 4, a system 80 includes an onboard charger and magnetically integrated high voltage/low voltage DC/DC converter 82, high voltage loads 84, a switch bank 86, a traction battery 88, and a low voltage battery 90 (e.g., 12V battery). The system 80 is shown within the context of vehicle 91.

The onboard charger and magnetically integrated high voltage/low voltage DC/DC converter 82 is connected between an AC source 92 (when present) and high voltage loads 84. The high voltage loads 84 are connected between the onboard charger and magnetically integrated high voltage/low voltage DC/DC converter 82 and switch bank 86. The switch bank 86 is connected between the high voltage loads 84 and traction battery 88.

The onboard charger and magnetically integrated high voltage/low voltage DC/DC converter 82 includes a single/three phase bidirectional totem pole power factor correction circuit 94 and a three port isolated DC/DC converter 96. The single/three phase bidirectional totem pole power factor correction circuit 94 is connected between the AC source 92 and three port isolated DC/DC converter 96. The three port isolated DC/DC converter 96 is connected between the single/three phase bidirectional totem pole power factor correction circuit 94 and high voltage loads 84.

The single/three phase bidirectional totem pole power factor correction circuit 94 includes a switch bank 98 and an AC/DC power converter 100. The switch bank 98 is connected between the AC source 92 (when present) and AC/DC power converter 100. The AC/DC power converter 100 is connected between the switch bank 98 and three port isolated DC/DC converter 96.

The three port isolated DC/DC converter 96 includes a switching bridge 102, a transformer 104, a switching bridge 106, a link capacitor 108, and a rectifier 110. The switching bridge 102 is connected between the AC/DC power converter 100 and transformer 104. The transformer 104 is connected between the switching bridges 102, 106, the switching bridge 106 is connected between the transformer 104 and link capacitor 108. The link capacitor 108 is connected between the switching bridge 106 and high voltage loads 84. The rectifier 110 is magnetically coupled with the transformer 104 via a low voltage coil and common core. The low voltage battery 90 is connected with the rectifier 110.

If the low voltage battery 90 is removed, a single point issue could take the high voltage bus offline and interrupt the low voltage power delivery to loads. This is because the low voltage battery 90 would no longer be used as a backup. In certain systems, the power to low voltage components should not be interrupted and stay above some threshold value even if the traction battery voltage drops below that which the high voltage/low voltage DC/DC converter 96 can support. Additionally, the low voltage battery 90 should be capable of supporting the loads if the high voltage/low voltage DC/DC converter 96 becomes unavailable. Removing the low voltage battery 90 battery may lead to other countermeasures. There is a need for an architecture that enables removing or significantly downsizing the low voltage battery 90 while minimizing hardware additions.

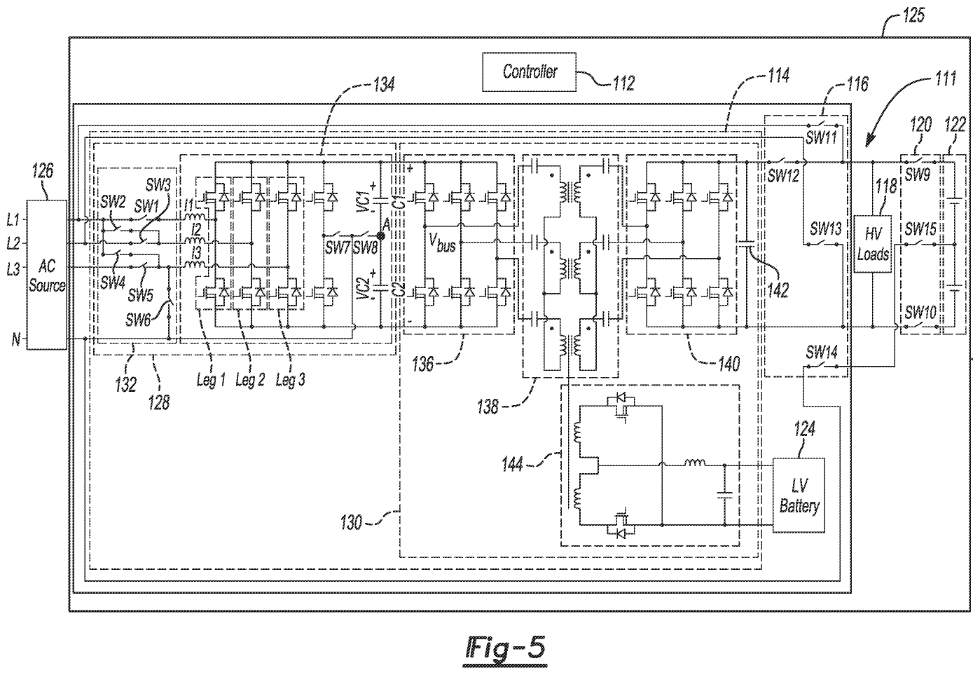

Referring to FIG. 5, as system 111 includes a controller 112, an onboard charger and magnetically integrated high voltage/low voltage DC/DC converter 114, a switch bank 116, high voltage loads 118, a switch bank 120, a traction battery 122, and a low voltage battery 124 (e.g., 12V battery). The system 111 is shown within the context of vehicle 125. The controller 112 is in communication with and/or exerts control over the components of FIG. 5.

The onboard charger and magnetically integrated high voltage/low voltage DC/DC converter 114 is connected between an AC source 126 (when present) and switch bank 116. The switch bank 116 is connected between the onboard charger and magnetically integrated high voltage/low voltage DC/DC converter 114 and high voltage loads 118. (That is, at least some switches of the switch bank 116 have at least one terminal connected between the onboard charger and magnetically integrated high voltage/low voltage DC/DC converter 114 and high voltage loads 118.) The high voltage loads 118 are connected between the switch banks 116, 120. The switch bank 120 is connected between the high voltage loads 118 and traction battery 122.

The onboard charger and magnetically integrated high voltage/low voltage DC/DC converter 114 includes bidirectional power factor correction circuitry (e.g., a single/three phase bidirectional totem pole power factor correction circuit) 128 and an isolated DC/DC converter (e.g., a three port isolated DC/DC converter) 130. The single/three phase bidirectional totem pole power factor correction circuit 128 is connected between the AC source 126 (when present) and three port isolated DC/DC converter 130. The three port isolated DC/DC converter 130 is connected between the single/three phase bidirectional totem pole power factor correction circuit 128 and switch bank 116.

The single/three phase bidirectional totem pole power factor correction circuit 128 includes a switch bank 132 and an AC/DC power converter 134. The switch bank 132 is connected between the AC source 126 (when present) and AC/DC power converter 134. The AC/DC power converter 134 is connected between the switch bank 132 and three port isolated DC/DC converter 130.

The three port isolated DC/DC converter 114 includes a switching bridge 136, a transformer 138, a switching bridge 140, a link capacitor 142, and a rectifier 144. The switching bridge 136 is connected between the AC/DC power converter 134 and transformer 138. The transformer 138 is connected between the switching bridges 136, 140, the switching bridge 140 is connected between the transformer 138 and link capacitor 142. The link capacitor 142 is connected between the switching bridge 140 and switch bank 116. The rectifier 144 is magnetically coupled with the transformer 138 via a low voltage coil and common core. The low voltage battery 124 is connected with the rectifier 144.

The switch bank 132 includes switches SW1, SW2, SW3, SW4, SW5, SW6. The AC/DC power converter 134 includes Leg 1, Leg 2, Leg 3, inductors 11, 12, 13, series switches SW7, SW8, and series capacitors C1, C2. Node A is shared by terminals of the capacitors C1, C2 and a terminal of the switch SW8. The switch bank 120 includes switches SW9, SW10, SW15. The switch bank 116 includes switches SW11, SW12, SW13, SW14 (e.g., relays).

The onboard charger's circuitry is thus used to construct a high voltage to low voltage DC/DC converter with three input ports. The traction battery 122 is split into two halves, with the switch SW9 disconnecting the traction battery's positive terminal from the high voltage bus and the switch SW10 disconnecting the traction battery's negative terminal from the high voltage bus. The switch SW15 is added to the battery pack for disconnecting the battery's midpoint from the high voltage system.

When the vehicle 125 is not connected to the AC grid source 126 or is in drive mode, the onboard charger's AC input is connected to the traction battery's three terminals by configuring the switch banks 116, 120, 132 as follows. Under normal operation, the switches SW9, SW10, SW15 are closed. The switches SW2, SW4 are opened to allow each respective phase of the AC/DC power converter 134 to connect to a different input source. The switch SW12 is opened to disconnect the onboard charger's secondary rectifier 140 from the traction battery 122. Only the positive bus is opened while the negative bus is still connected to the traction battery 122. Alternatively, the switch SW12 can be connected such that the negative bus is disconnected from the traction battery 122 while the high voltage bus remains connected. The switches SW1, SW11 are closed to connect the traction battery's positive terminal to L1 (line 1). The switches SW3, SW13 are closed to connect the traction battery's negative terminal to L2 (line 2). The switches SW6, SW14 are closed while the switch SW5 is open to allow connecting the traction battery's midpoint to N (neutral). The switch SW8 is closed, while the switch SW7 is open for connecting the neutral and the traction battery's midpoint to point A.

The AC/DC power stage 134 acts as a boost converter stepping up the voltage from each half of the traction battery 122. Two bi-directional half-bridge active boost rectifiers are formed by Leg 1 and Leg 2. A bi-directional buck/boost converter is formed by Leg 3. Current flowing through the inductor 13 is controlled to ensure that the neutral line voltage is centered between the high voltage DC rails. That is, the voltage across C1 and C2 is balanced (VC1=VC2=Vbus/2). To ensure voltage balance across C1 and C2, the buck/boost converter has two modes of operation: (1) Buck mode (if VC2<Vbus/2) in which it injects current to charge C2 (this condition occurs if the switch SW10 is opened due to a single point issue in the traction battery 122); (2) Boost mode (if VC2>Vbus/2) in which it withdraws current to discharge C2 (this condition occurs if the switch SW9 is opened due to a single point issue in the traction battery 122). A single point fault that requires opening either the switch SW9 or the switch SW10 does not interrupt the DC link voltage (Vbus).

A high-voltage to low-voltage DC-DC converter is formed by switching the primary bridge 136 referenced to the high voltage AC side and the secondary bridge 140 referenced to the low voltage DC side. The primary high voltage AC side primary bridge 136 and the secondary side low voltage DC side secondary bridge 140 are magnetically coupled through the transformer 138. The high voltage AC bridge 136 is responsible for taking a DC input and outputting an AC voltage/current to energize a primary winding of the transformer 138. The high voltage DC bridge 140 is responsible for taking an AC voltage and AC current at its input and converting it to a DC voltage or DC current with the help of inductive or capacitive filtering components.

Reverse power can flow from the low voltage battery 124 to the traction battery 122 by operating the high voltage DC bridge 140 as an inverter and the high voltage AC bridge 136 as a rectifier.

When the vehicle 125 is connected to the AC source 126 for charging the traction battery 122, low voltage output is provided by the three-port transformer 138 in which the low voltage coil of the rectifier 144 is magnetically coupled to a coil of the transformer 138 referenced to the high voltage AC side and a coil of the transformer 138 referenced to the high voltage DC side.

Closing the switches SW11, SW13, SW14, SW15 requires the vehicle's AC port to be closed since high voltage DC is applied across the AC pins. If this locking mechanism is not implemented, additional relays may be added to disconnect the AC port pins from the traction battery 122 while the vehicle 125 is in drive mode or not connected to the AC source 126.

During grid to vehicle or vehicle to grid operations, the switches SW11, SW13, SW14, SW15 are open while the switch SW12 is closed.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
bidirectional power factor correction circuitry having line and neutral terminals configured to be connected with an AC source;
a traction battery having positive and negative terminals and a midpoint;
an isolated DC/DC converter connected between the bidirectional power factor correction circuitry and traction battery; and
a plurality of switches configured to selectively connect the positive and negative terminals directly to the line terminals and the midpoint directly to the neutral terminal.

2. The vehicle of claim 1, wherein the bidirectional power factor correction circuitry is a bidirectional totem pole power factor correction circuit.

3. The vehicle of claim 1, wherein the isolated DC/DC converter is a three port isolated DC/DC converter.

4. The vehicle of claim 3 further comprising an auxiliary battery connected with the three port isolated DC/DC converter.

5. The vehicle of claim 4, wherein the three port isolated DC/DC converter includes a transformer and a rectifier magnetically coupled with the transformer.

6. The vehicle of claim 4, wherein the three port isolated DC/DC converter is configured to selectively transfer power from the auxiliary battery to the traction battery.

7. The vehicle of claim 1 further comprising a controller programmed to, responsive to the line and neutral terminals being connected with an AC source, disconnect the positive and negative terminals from the line terminals and the midpoint from the neutral terminal.

8. A method comprising:
after disconnecting line and neutral terminals associated with bidirectional power factor correction circuitry of a vehicle from an AC source, directly connecting the line terminals to positive and negative terminals of a traction battery of the vehicle and the neutral terminal to a midpoint of the traction battery such that power flows from the traction battery through the bidirectional power factor correction circuitry to an isolated DC/DC converter connected between the bidirectional power factor correction circuitry and traction battery.

9. The method of claim 8 further comprising disconnecting the line terminals from the positive and negative terminals and the neutral terminal from the midpoint such that power from the AC source when connected with the line and neutral terminals flows through the bidirectional power factor correction circuitry and isolated DC/DC converter to charge the traction battery.

10. The method of claim 8 further comprising operating the isolated DC/DC converter to transfer power from an auxiliary battery connected with the isolated DC/DC converter to the traction battery.

11. An automotive power system comprising:
bidirectional power factor correction circuitry having line and neutral terminals configured to be connected with an AC source;
a traction battery having positive and negative terminals and a midpoint;
an isolated DC/DC converter connected between the bidirectional power factor correction circuitry and traction battery; and
a controller programmed to, during a drive mode, connect the positive and negative terminals directly to the line terminals and the midpoint directly to the neutral terminal such that power from the traction battery flows through the bidirectional power factor correction circuitry and to the isolated DC/DC converter.

12. The automotive power system of claim 11, wherein the controller is further programmed to, during a charge mode, disconnect the positive and negative terminals from the line terminals and the midpoint from the neutral terminal such that power from an AC source flows through the bidirectional power factor correction circuitry and isolated DC/DC converter to charge the traction battery.

13. The automotive power system of claim 11 further comprising an auxiliary battery connected with the isolated DC/DC converter.

14. The automotive power system of claim 13, wherein the controller is further programmed to operate the isolated DC/DC converter to transfer power from the auxiliary battery to the traction battery.

15. The automotive power system of claim 11, wherein the bidirectional power factor correction circuitry is a bidirectional totem pole power factor correction circuit.

16. The automotive power system of claim 11, wherein the isolated DC/DC converter is a three port isolated DC/DC converter.

17. The automotive power system of claim 16, wherein the three port isolated DC/DC converter includes a transformer and a rectifier magnetically coupled with the transformer.
